(19) United States
(12) Patent Application Publication
(10) Pub. No.: US 2026/0154729 A1
(43) Pub. Date: Jun. 4, 2026

(54) METHODS AND SYSTEM FOR PROGRAMMATIC LOCATION SELECTION OF DISPLAYS BASED ON AVAILABILITY METRICS

(71) Applicant: 14334647 CANADA CORP., Barrie (CA)

(72) Inventors: Tyler Garry COOPER, Barrie (CA); Kamila Julianna DOMANSKA, Barrie (CA); Garry Trevor COOPER, Barrie (CA)

(21) Appl. No.: 19/457,505

(22) Filed: Jan. 23, 2026

Related U.S. Application Data
(63) Continuation of application No. PCT/CA2024/050981, filed on Jul. 24, 2024.
(60) Provisional application No. 63/515,500, filed on Jul. 25, 2023.

(51) Int. Cl. G06Q 30/0601; G06Q 30/08

(52) U.S. Cl. CPC G06Q 30/0639; G06Q 30/08

(57) ABSTRACT

Computer-implemented methods and systems for matching media assets to physical locations. The method comprises obtaining physical location information, from a first server, that includes at least one source identifier associated with at least one category of item, and obtaining a plurality of locations from a second server. A request from the first server is received for displaying a media asset associated with the at least one source identifier at one or more of the plurality of locations. At least one suitable location from the plurality of locations is determined based on matching the at least one source identifier to a physical availability of the at least one source identifier at each location of the plurality of locations. The media asset is provided for display at the at least one suitable location.

### CROSS-REFERENCE TO RELATED APPLICATIONS

This application is a continuation of PCT Application No. PCT/CA2024/050981, filed Jul. 24, 2024, which claims priority to U.S. Provisional Application No. 63/515,500, filed Jul. 25, 2023, the entire contents of which are hereby incorporated by reference for all purposes.

### TECHNICAL FIELD

The disclosed exemplary embodiments relate to methods and systems for programmatic location selection of displays based on availability metrics.

### BACKGROUND

Digital screens or displays are used in a wide variety of contexts to display static and dynamic images, including images, videos, quick response (QR) codes, and augmented reality registration markers. Generally, digital screens are controlled by a computer, which executes a program that obtains the images or video, and transmits them for display on the digital screen, usually via a graphics card. In some cases, the digital screen may incorporate the computer internally, such that an external device is unnecessary. In some use cases, the computer may be networked, so that it can receive images or videos for display. The images or videos may be displayed immediately upon receipt or, alternatively, they may be cached or stored on a local storage device for display at a later time.

### SUMMARY

The following summary is intended to introduce the reader to various aspects of the detailed description, but not to define or delimit any invention.

In at least one broad aspect, there is provided a method for matching media assets to physical locations, the method comprising: obtaining, from a first server, physical location information, wherein the physical location information comprises at least one source identifier associated with at least one category of item; obtaining, from a second server, a plurality of locations; receiving a request to display a media asset associated with the at least one source identifier at one or more of the plurality of locations; determining at least one suitable location from the plurality of locations to display the media asset, the at least one suitable location determined based on matching the at least one source identifier to a physical availability of the at least one source identifier at each location of the plurality of locations; and providing the media asset for display at the at least one suitable location.

In some cases, the physical location information may further comprise at least one of an identifier, a price range, an address, a GPS location, a date range, and an engagement factor.

In some cases, the physical location information may further comprise an aspect ratio and/or dimensions of a display screen for displaying the media asset.

In some cases, the receiving the request may comprise receiving a bid request from the first server.

In some cases, the determining the at least one suitable location may comprise obtaining information on a range of source identifiers available at each location of the plurality of locations.

In some cases, the method may further comprise facilitating a transaction between the first server and the second server.

In some cases, the at least one category of item may correspond to a product or a service.

In another broad aspect, there is provided a method for matching media assets to physical locations, the method comprising: obtaining, at a server, physical location information, wherein the physical location information comprises at least one source identifier associated with at least one category of item; providing the physical location information to an exchange server; providing a request to display a media asset associated with the at least one source identifier to the exchange server; receiving, at the server, at least one suitable location based on matching the at least one source identifier to a physical availability of the at least one source identifier at each location of a plurality of locations; and providing the media asset for display at the at least one suitable location.

In some cases, the physical location information may further comprise at least one of an identifier, a price range, an address, a GPS location, a date range, and an engagement factor.

In some cases, the physical location information may further comprise an aspect ratio and/or dimensions of a display screen for displaying the media asset.

In some cases, providing the request may comprise transmitting a bid request from the first server.

In some cases, the at least one category of item may correspond to a product or a service.

In another broad aspect, there is provided a method for matching media assets to physical locations, the method comprising: obtaining, at a server, a plurality of locations; providing the plurality of locations to an exchange server; receiving, at the server, a request to display a media asset associated with at least one source identifier associated with at least one category of item; receiving, at the server, at least one suitable location based on matching the at least one source identifier to a physical availability of the at least one source identifier at each location of the plurality of locations; and displaying the media asset at the at least one suitable location.

In some cases, the plurality of locations may be based on at least one of an identifier, a price range, an address, a GPS location, a date range, and an engagement factor.

In some cases, the plurality of locations may be further based on an aspect ratio and/or dimensions of a display screen for displaying the media asset.

In some cases, the receiving the at least one suitable location may comprise accepting a bid request.

In some cases, the at least one category of item may correspond to a product or a service.

In another aspect, there is provided a system comprising: a first server configured to provide physical location information, wherein the physical location information comprises at least one source identifier associated with at least one category of item; a second server configured to provide a plurality of locations; an exchange server configured to: determine at least one suitable location from the plurality of locations to display a media asset associated with the at least one source identifier, the at least one suitable location determined based on matching the at least one source identifier to a physical availability of the at least one source identifier at each location of the plurality of locations; and a plurality of displays configured to display the media asset.

In some cases, the physical location information further may comprise at least one of an identifier, a price range, an address, a GPS location, a date range, and an engagement factor.

In some cases, the physical location information may further comprise an aspect ratio and/or dimensions of the media asset.

In some cases, the exchange server may be configured to receive a bid request from the first server.

In some cases, the exchange server may determine the at least one suitable location based on information on a range of source identifiers available at each location of the plurality of locations.

In some cases, the exchange server may be configured to facilitate a transaction between the first server and the second server.

In some cases, the at least one category of item may correspond to a product or a service.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of an exemplary system for programmatic location selection of displays based on availability metrics in accordance with at least some embodiments;

FIG. 2 is a block diagram of a computer in accordance with at least some embodiments;

FIG. 3 is a block diagram of modules within servers in the system of FIG. 1;

FIG. 4 is a flowchart diagram of an exemplary method for programmatic location selection of display based on product availability for execution by the system of FIG. 1;

FIG. 5 is a flowchart diagram of another exemplary method for programmatic location selection of display based on product availability for execution by the system of FIG. 1; and

FIG. 6 is a flowchart diagram of another exemplary method for programmatic location selection of display based on product availability for execution by the system of FIG. 1.

### DETAILED DESCRIPTION

In at least some use cases, digital screens may be used to display visual or media assets that relate to products or services. The availability or suitability of a digital screen to display a particular media asset can be based on a variety of metrics. For instance, size and aspect ratio are often a factor in selecting digital screens. The physical location of a digital screen is another metric. For example, when communicating information that is relevant to a particular geographical area, the location of a screen may be a metric of high relevance. Location may also have varying levels of granularity. For example, a broad location may be based on a region, municipality or postal code. A more fine-grained location may be based on street address or latitude and longitude, and even further specific locations may be based on qualitative factors, such as whether a location is indoor or outdoor. In some cases, location may be relative to some other structure or landmark. For example, one type of location may be a proximity to some other point and some display locations may be categorized as being “on-premises” or “off-premises,” where the premises is a parcel of land occupied by some other structure.

For example, when displaying images relating to products or services, such as for advertising, there may be constraints surrounding the images displayed in particular locations. In particular, some jurisdictions may require a physical display that is on-premises be constrained to displaying media assets that relate to the actual products or services that are physically available to customers at the premises. However, conventionally, it has not always been possible to programmatically determine the products or services available at specific premises.

Some jurisdictions may also impose requirements for off-premises displays, similarly constraining the media assets that may be displayed. Conventional systems for determining where media assets are displayed are not able to determine if a specific product or service is available at each location where there is a display, and rely on user or operator knowledge of where the product or service is available.

The described embodiments provide for the ability to match media assets for display on digital screens at specific physical locations, including based on availability metrics such as proximity to products or services to which the media asset relates, and the physical availability of the product or service at the locations of the displays.

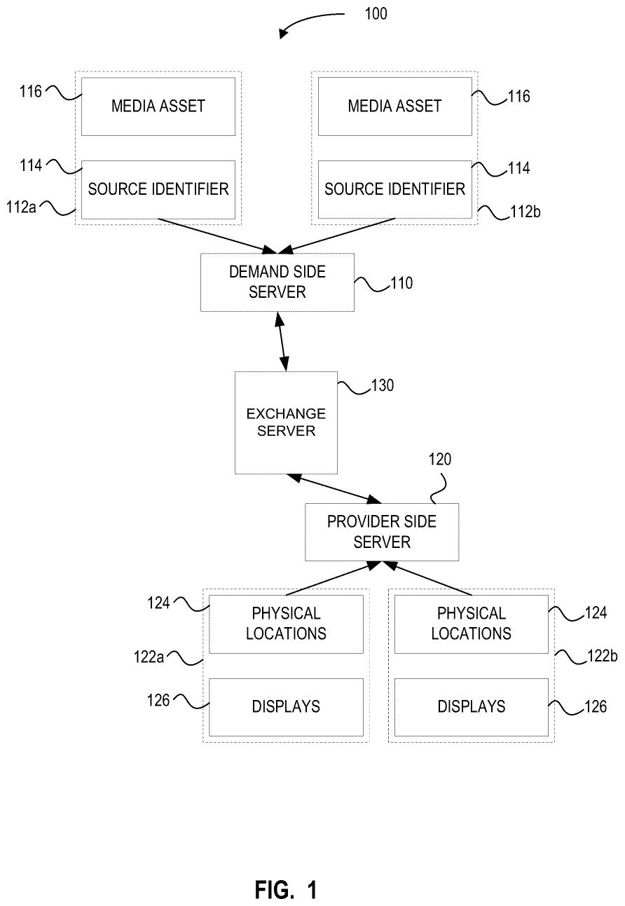

Referring now to FIG. 1, there is illustrated a schematic block diagram of a computer system in accordance with at least some embodiments.

An example system 100 includes a demand side server 110, a provider side server 120, and an exchange server 130, the servers 110, 120, 130 being operatively coupled by a network.

A demand side user 112a, 112b provides information to the demand side server 110 that includes at least one source identifier 114 that may be associated with at least one category of item. Based on the provided information, the demand side server 110 creates a bid request or campaign for the user 112a, 112b which is sent to the exchange server 130.

A provider 122a, 122b provides information to the provider side server 120 that includes a plurality of physical locations 124 that have displays 126 capable of displaying a media asset 116. Based on the provided information, the provider side server 120 creates an inventory profile for the provider 122a, 122b which is sent to the exchange server 130.

The exchange server 130 determines at least one suitable location for the media asset 116 to be displayed based on matching the source identifier 114 to the physical locations 124, as described further herein. In some cases, the exchange server 130 supplies the media asset 116 supplied by the demand side user 112a, 112b to the provider 122a, 122b, which can control or schedule the display thereof on a display 126. The media asset 116 may be a physical static image such as a billboard poster, or a digital image, or a video, for display on a respective display 126. In some cases, the media asset may include a quick response (QR) code, or an augmented reality registration marker. There may be more than one display 126 at a physical location 124.

The servers 110, 120, 130 may be cloud based or may be physical computers that are networked via conventional Internet connections. The demand side user 112a, 112b may access the demand side server 110 via a web-based application or via a client program executed locally on a computer. The provider 122a, 122b may access the provider side server 120 via a web-based application or a client program executed locally on a computer.

A single demand side user 112a, 112b may create a bid request or campaign on the demand side server 110 that is suitable for display at locations provided by more than one provider 122a, 122b. Similarly, a single provider 122a, 122b may display media assets 116 from more than one demand side user 112a, 112b on its displays 126.

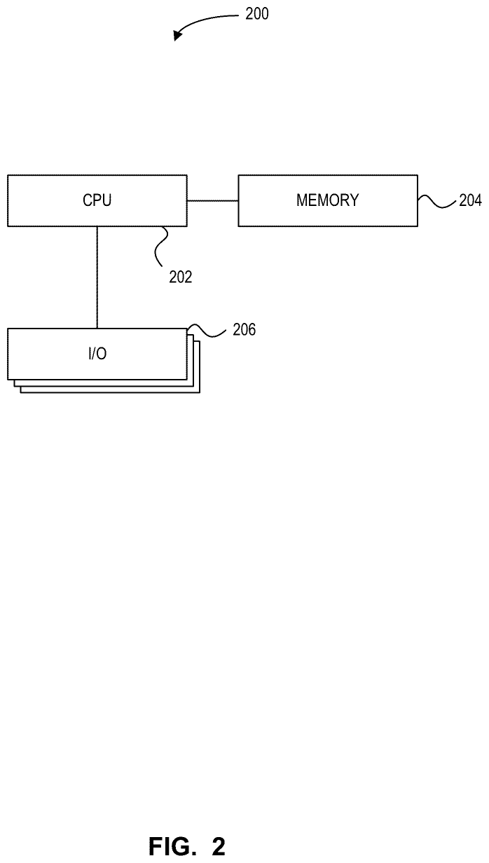

Referring now to FIG. 2, there is illustrated a simplified block diagram of a computer in accordance with at least some embodiments. Computer 200 is a generic example of a computer, such as the servers 110, 120, 130 of FIG. 1. Computer 200 generally has at least one processor 202 operatively coupled to at least one memory 204, and at least one additional input/output device 206.

The at least one memory 204 includes a volatile memory that stores instructions executed or executable by processor 202, and input and output data used or generated during execution of the instructions. Memory 204 may also include non-volatile memory used to store input and/or output data along with program code containing executable instructions.

Processor 202 may transmit or receive data via a data communications interface (not shown), or may also transmit or receive data via any additional input/output device 206 as appropriate.

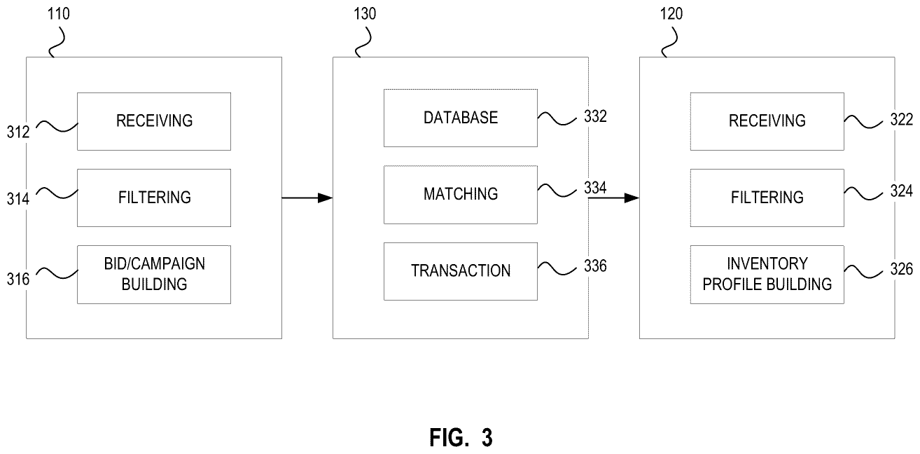

Referring now to FIG. 3, there is illustrated a simplified block diagram of the servers 110, 120, 130 and their respective modules. The term “module” as used herein refers to related functionality provided by the respective computer. For example, the “filtering” module of demand side server 110 may be implemented as a computer program executed by a processor of the demand side server 110 to carry out the “filtering” functionality described further herein.

The demand side server 110 may comprise several modules including, but not limited to, a receiving module 312, a filtering module 314, and a bid or campaign building module 316.

The provider side server 120 may comprise several modules including, but not limited to, a receiving module 322, a filtering module 324, and an inventory profile building module 326.

The exchange server 130 may comprise several modules including, but not limited to, a matching module 334 and a transaction module 336. The exchange server 130 may also comprise a database 332.

To create a bid or campaign at the demand side server 110, to provide to the exchange server 130, the demand side user 112a, 112b may input information at the demand side server 110. Alternatively, an application programming interface (API) may be offered by demand side server 110 (or, in some cases, by exchange server 130) to enable programmatic input of bid or campaign data. The receiving module 312 of the demand side server 110 receives input relating to physical location information of at least one source identifier 114 associated with at least one category of item. The at least one source identifier may relate to a specific brand name or trademark. The at least one category of item may relate to a physical product or service. The physical location information may relate to locations where the demand side user 112a, 112b wishes to display the media asset 116.

The demand side user 112a, 112b may refine the physical location information by providing an input to the filtering module 314. The filtering module 314 contains several options available for selection to refine the physical location information relating to the source identifier 114. The options provided by the filtering module 314 may include, but are not limited to: an identifier, a price range, an address, a Global Positioning System (GPS) location, a date range, and an engagement factor. The identifier may relate to the category of item which may be a physical product or service within the scope of the source identifier 114. The demand side user 112a, 112b may wish to refine the physical location information based on the category of item. For example, the source identifier 114 may correspond to multiple categories of item, and the demand side user 112a, 112b may wish to build a campaign relating to only one category of item. The demand side user 112a, 112b may wish to build a campaign relating to a portion of the categories of items associated with the source identifier 114. The demand side user 112a, 112b may wish to build a campaign relating to all categories of item associated with the source identifier 114. In some cases, the source identifier 114 may be associated with only one category of item.

The price range may include a range of prices that is acceptable for the demand side user 112a, 112b to pay for facilitating the display of the media asset 116, and/or the cost per thousand impressions (CPM) that is acceptable to the demand side user 112a, 112b, or similar. The address may be a postal code or street address, or multiple postal codes or street addresses, relating to where the demand side user 112a, 112b desires the media asset 116 to be visible. The GPS location may be GPS coordinates relating to where the demand side user 112a, 112b desires the media asset 116 to be visible. The date range may be a period of time that the media asset 116 will be visible. The engagement factor may relate to a desired audience measurement data metric. The filtering module 314 may also include options for refining the physical location information for the source identifier 114 that relate to an aspect ratio or physical dimensions of the media asset 116 for display.

Once this information has been supplied to the demand side server 110 by the demand side user 112a, 112b, the bid or campaign building module 316 creates a bid, requesting the display of the media asset 116 at potential locations. The bid request is sent to the exchange server 130.

At the provider side server 120, at the receiving module 322 a provider 122a, 122b inputs a plurality of locations relating to physical locations 124 with displays 126 capable of displaying the media asset 116. The displays 126 may be static displays or may be electronic screen displays capable of display both static images and videos, QR codes, or an augmented reality registration marker. The displays 126 may be permanently installed at a physical location 124, or may be mobile, with the ability to be moved from one physical location 124 to another.

The provider 122a, 122b may refine the types of media assets 116 that may be displayed on the displays 126 at their physical locations 124 by providing an input to the filtering module 324. The filtering module 324 contains a number of options available for selection to refine the information relating to the physical locations 124 and displays 126. The options provided by the filtering module 124 may include, but are not limited to: an identifier, a price range, an address, a Global Positioning System (GPS) location, a date range, and an engagement factor.

The identifier may relate to a variety of different source identifiers 114, or to a variety of categories of item, or both. For example, the provider 122a, 122b may wish to limit the media assets 116 displayed at their displays 126 based on a particular category of item, therefore including some products or services, and excluding others, while being impartial to the source identifier 114. The provider 122a, 122b may wish to limit media assets 116 displayed at their displays 126 based on their own knowledge of source identifiers 114 available at the physical locations 124 where their displays 126 are located, therefore including some source identifiers 114 and excluding others (e.g. the provider 122a, 122b may be willing to display media assets 116 for products or services corresponding to a first brand name, but not those corresponding to a second brand name as they are not physically available). The provider 122a, 122b may wish to limit media assets 116 displayed at their displays based on both source identifier 114 and category of item. For example, the provider 122a, 122b may specify that they are willing to display media assets 116 for a particular brand or brands, but only a portion of the products or services within the scope of that brand, therefore including some categories of item with the scope of a source identifier 114 and excluding others.

The price range may include a range of prices that represent acceptable payment to the provider 122a, 122b for facilitating the display of the media asset 116, and/or the CPM that is acceptable, or similar. The address may be a postal code or street address, or multiple postal codes or street addresses, relating to the physical locations 124 of the displays 126 where the media asset 116 may be visible. The GPS location may be GPS coordinates relating to the physical locations 124 of the displays 126 where the media asset 116 may be visible. The date range may be a period of time that the displays 126 at the physical locations 124 are available to display the media asset 116. The engagement factor may relate to an audience measurement data metric for the displays 126 at the physical locations 124. The filtering module 324 may also include options for refining the physical locations 124 to include an aspect ratio or physical dimensions of the displays 126 available at the physical locations 124.

Once this information has been supplied to the provider side server 120 by the provider 122a, 122b, the inventory profile building module 326 creates or updates an inventory of displays 126 at the physical locations 124. The inventory profile is sent to the exchange server 130.

The exchange server 130 receives the physical location information from the demand side server 110, and receives the inventory profile from the provider side server 120. The exchange server 130 identifies whether the source identifier 114 is physically available at any of the physical locations 124 based on the information in the database 332. The database 332 contains information of a variety of different source identifiers, e.g. brand names, and categories of items, e.g. products or services, physically available at a plurality of different locations.

The exchange server 130 receives the bid request from the demand side server 110, and the profile inventory from the provider side server 120. The matching module 334 analyses the information in the bid request to the determine the source identifier 114 and where the demand side user 112a, 112b wishes to have the media asset 116 displayed. The matching module 334 analyses the information in the inventory profile to determine the physical locations 124 of displays 126 available. The matching module 334 uses database 332 to determine a suitable location or locations for displaying the media asset 116 based on where the source identifier 114 is physically available. Once the suitable location or locations have been determined, the exchange server 130 may facilitate an exchange between the demand side user 112a, 112b and the provider 122a, 122b, completing the bid request process. The media asset 116 is provided by the demand sider user 112a, 112b at the demand side server 110 and provided to the provider 122a, 122b at the provider side server 120 via the exchange server 130. The provider 122a, 122b then displays the media asset 116 at the displays 126 at the suitable location or locations identified by the matching module 334. The media asset 116 is displayed at the suitable locations as determined by the bid request (e.g. length of time).

The matching module 334 uses database 332 to determine if the source identifier 114 identified by the demand side user is physically available at any of the physical locations 124 with displays 126 identified by the provider 122a, 122b. Physical locations 124 with displays 126 where the source identifier 114 is physically available are suitable locations for the media asset 116 to be displayed.

Although the database 332 is shown in FIG. 3 as being a single database hosted at the exchange server 130, it may be hosted on another server, or be cloud-based. Similarly, the information used for matching may be contained in one database, such as database 332, or be contained in multiple different databases. The information used for matching may also be acquired from different sources, such as from the inventory profiles built by the providers 122a, 122b.

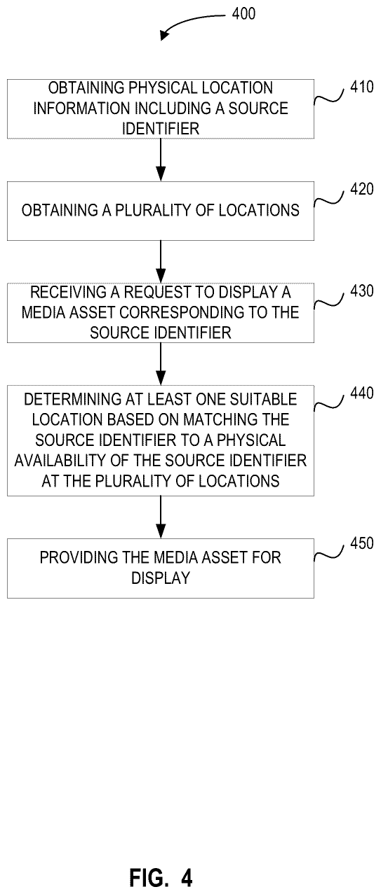

Referring now to FIG. 4, there is provided a method 400 for matching media assets 116 to be displayed at physical locations 124 from the perspective of the exchange server 130.

At step 410 the exchange server 130 obtains physical location information from the demand side server 110 that includes at least one source identifier 114 that may be associated with at least one category of item. The physical information provided can include an identifier, a price range, an address, a Global Positioning System (GPS) location, a date range, an engagement factor, and an aspect ratio or physical dimensions of the media asset 116 for display.

At step 420 the exchange server 130 obtains information pertaining to displays 126 at physical locations 124 from the provider side server 120, e.g., an inventory profile. The information pertaining to the displays 126 at physical locations 124 can include an identifier, a price range, an address, a Global Positioning System (GPS) location, a date range, an engagement factor, and an aspect ratio or physical dimensions of a display 126.

At step 430 the exchange server receives a request from the demand side server 110 to display the media asset 116 corresponding to the at least one source identifier 114. Based on the information in the request, the exchange server 130 determines at least one suitable location for displaying the media asset 116 at step 440. The request comprises a bid request that includes the physical location information.

At step 440, the exchange server 130 matches the at least one source identifier 114 in the bid request to the physical locations 124 and displays 126 in the inventory profile from provider side server 120. The matching determines the at least one suitable location for displaying the media asset 116. To determine the at least one suitable location, the exchange server 130 compares the at least one source identifier 114 provided in the bid request to information held in the database 332. The database 332 contains information pertaining to a plurality of brand names, products and services that are physically available at a plurality of locations. The exchange server 130 determines which of the physical locations 124 with displays 126 in the inventory profile are locations where the at least one source identifier 114 is physically available, based on the information held in the database 332. The at least one suitable location is therefore a physical location 124 with a display 126 where the at least one source identifier 114 is physically available.

At step 450 the exchange server 130 supplies the media asset 116 to the provider 122a, 122b for displaying at the displays 126 at the suitable location or locations.

The exchange server 130 can also facilitate a transaction between the demand side server 110 and the provider side server 120.

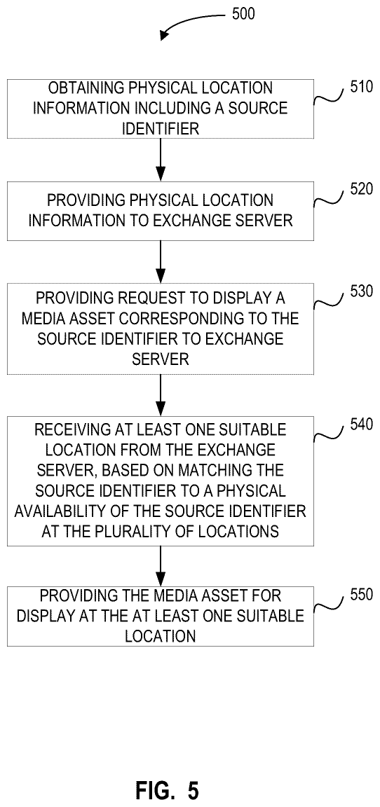

Referring now to FIG. 5, there is provided a method 500 for matching media assets 116 to be displayed at physical locations 124 from the perspective of the demand side server 110.

At step 510, the demand side server 110 obtains physical location information that includes the at least one source identifier 114 that may be associated with at least one category of item as an input from the demand side user 112a, 112b. The physical information provided can include an identifier, a price range, an address, a Global Positioning System (GPS) location, a date range, an engagement factor, and an aspect ratio or physical dimensions of an media asset 116 for display.

At step 520, the demand side server 110 provides the physical location information to the exchange server 130, which includes the at least one source identifier 114.

At step 530, the demand side server 110 builds a bid request to display the media asset 116 relating to the at least one source identifier 114. The demand side server 110 transmits the bid request to the exchange server 130.

At step 540, the demand side server 110 receives, from the exchange server 130, the suitable location or locations that the exchange sever 130 has identified. The exchange server 130 matches the at least one source identifier 114 in the bid request to the physical locations 124 and displays 126 in the inventory profile from provider side server 120. The matching determines the at least one suitable location for displaying the media asset 116. To determine the at least one suitable location, the exchange server 130 compares the at least one source identifier 114 provided in the bid request to information held in the database 332. The database 332 contains information pertaining to a plurality of brand names, products and services that are physically available at a plurality of locations. The exchange server 130 determines which of the physical locations 124 with displays 126 in the inventory profile are locations where the at least one source identifier 114 is physically available, based on the information held in the database 332. The at least one suitable location is therefore a physical location 124 with a display 126 where the at least one source identifier 114 is physically available.

At step 550, the demand side server 110 sends the media asset 116 to the exchange server 130.

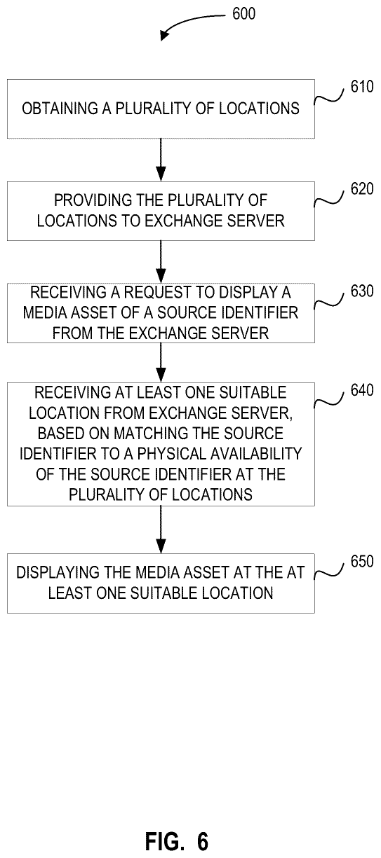

Referring now to FIG. 6, there is provided a method 600 for matching media assets 116 to be displayed at physical locations 124 from the perspective of the provider side server 120.

At step 610, the provider side server 120 obtains physical locations 124 as an input from the provider 122a, 122b. The physical locations 124 each have at least one display 126. The information pertaining to the displays 126 at physical locations 124 can include an identifier, a price range, an address, a Global Positioning System (GPS) location, a date range, an engagement factor, and an aspect ratio or physical dimensions of a display 126 and forms the inventory profile.

At step 620, the provider side server 120 provides the inventory profile comprising the physical locations 124 to the exchange server 130.

At step 630, the provider side server 120 receives, from the exchange server 130, a request (originating from the demand side server 110) to display a media asset 116. The media asset 116 corresponds to at least one source identifier 114.

At step 640, the provider side server 120 receives, from the exchange server 130, a suitable location or locations relating to the request received. The exchange server 130 matches the at least one source identifier 114 to the physical locations 124 and displays 126 in the inventory profile. The matching determines at least one suitable location for displaying the media asset 116. To determine the at least one suitable location, the exchange server 130 compares the at least one source identifier 114 provided in the request to information held in the database 332. The database 332 contains information pertaining to a plurality of brand names, products and services that are physically available at a plurality of locations. The exchange server 130 determines which of the physical locations 124 with displays 126 in the inventory profile are locations where the at least one source identifier 114 is physically available, based on the information held in the database 332. The at least one suitable location is therefore a physical location 124 with a display 126 where the at least one source identifier 114 is physically available.

At step 650, the media asset 116 is displayed on the displays 126 at the suitable location or locations.

Although the embodiments described above outline the demand side server 110, the provider side server 120, and the exchange server 130 as separate entities, in some cases the demand side server 110 may be integrated with the exchange server 130. In some cases, the provider side server 120 may be integrated with the exchange server 130. In some cases, the both the demand side server 110 and the provider side server 120 may be integrated with the exchange server 130. In some cases, the demand sider server 110 may be integrated with the provider side server 120.

The described system and methods enable demand side users seeking to have media assets displayed to build a bid request/campaign to be shared with providers that have displays at physical locations where the source identifier is physically available, with the exchange server ensuring that the source identifier is physically available. This provides an efficient and cost-effective process for both demand sider users and providers. The demand side user is able to create a bid request which can be shared with multiple providers through the exchange server, streamlining the coordination required. Similarly, the provider is able to receive multiple bid requests and display media assets for multiple demand sider users, maximising the use of their displays and maximizing revenue.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art. Although embodiments have been described above with reference to the accompanying drawings, those of skill in the art will appreciate that variations and modifications may be made without departing from the scope thereof as defined by the appended claims.

What is claimed is:

1. A system comprising:
a first server configured to provide physical location information, wherein the physical location information comprises at least one source identifier associated with at least one category of item;
a second server configured to provide a plurality of locations;
an exchange server configured to:
determine at least one suitable location from the plurality of locations to display a media asset associated with the at least one source identifier, the at least one suitable location determined based on matching the at least one source identifier to a physical availability of the at least one source identifier at each location of the plurality of locations; and
a plurality of displays configured to display the media asset.

2. The system of claim 1, wherein the physical location information further comprises at least one of an identifier, a price range, an address, a GPS location, a date range, and an engagement factor.

3. The system of claim 2, wherein the physical location information further comprises an aspect ratio and/or dimensions of the media asset.

4. The system of claim 1, wherein the exchange server is configured to receive a bid request from the first server.

5. The system claim 1, wherein the exchange server determines the at least one suitable location based on information on a range of source identifiers available at each location of the plurality of locations.

6. The system claim 1, wherein the exchange server is configured to facilitate a transaction between the first server and the second server.

7. The system of claim 1, wherein the at least one category of item corresponds to a product or a service.

8. A method for matching media assets to physical locations, the method comprising:
obtaining, from a first server, physical location information, wherein the physical location information comprises at least one source identifier associated with at least one category of item;
obtaining, from a second server, a plurality of locations;
receiving a request to display a media asset associated with the at least one source identifier at one or more of the plurality of locations;
determining at least one suitable location from the plurality of locations to display the media asset, the at least one suitable location determined based on matching the at least one source identifier to a physical availability of the at least one source identifier at each location of the plurality of locations; and
providing the media asset for display at the at least one suitable location.

9. The method of claim 8, wherein the physical location information further comprises at least one of an identifier, a price range, an address, a GPS location, a date range, and an engagement factor.

10. The method of claim 9, wherein the physical location information further comprises an aspect ratio and/or dimensions of a display screen for displaying the media asset.

11. The method of claim 8, wherein the receiving the request comprises receiving a bid request from the first server.

12. The method of claim 8, wherein the determining the at least one suitable location comprises obtaining information on a range of source identifiers available at each location of the plurality of locations.

13. The method of claim 8, further comprising facilitating a transaction between the first server and the second server.

14. The method of claim 8, wherein the at least one category of item corresponds to a product or a service.

15. A non-transitory computer readable medium storing instructions executable by a computer processor, the instructions when executed by the computer processor cause the computer process to carryout a method for matching media assets to physical locations, the method comprising:
obtaining, from a first server, physical location information, wherein the physical location information comprises at least one source identifier associated with at least one category of item;
obtaining, from a second server, a plurality of locations;
receiving a request to display a media asset associated with the at least one source identifier at one or more of the plurality of locations;
determining at least one suitable location from the plurality of locations to display the media asset, the at least one suitable location determined based on matching the at least one source identifier to a physical availability of the at least one source identifier at each location of the plurality of locations; and
providing the media asset for display at the at least one suitable location.

16. The non-transitory computer readable medium of claim 15, wherein the physical location information further comprises at least one of an identifier, a price range, an address, a GPS location, a date range, and an engagement factor.

17. The non-transitory computer readable medium of claim 16, wherein the physical location information further comprises an aspect ratio and/or dimensions of a display screen for displaying the media asset.

18. The non-transitory computer readable medium of claim 15, wherein the receiving the request comprises receiving a bid request from the first server.

19. The non-transitory computer readable medium of claim 15, wherein the determining the at least one suitable location comprises obtaining information on a range of source identifiers available at each location of the plurality of locations.

20. The non-transitory computer readable medium of claim 15, wherein the at least one category of item corresponds to a product or a service.
